(19) United States
(12) Patent Application Publication
(10) Pub. No.: US 2017/0059958 A1
(43) Pub. Date: Mar. 2, 2017

(54) TANDEM-PHASE-MODULATOR-BASED OPTICAL ISOLATOR IN SILICON

(71) Applicant: ACACIA COMMUNICATIONS INC., MAYNARD, MA (US)

(72) Inventors: Christopher DOERR, MAYNARD, MA (US); Long CHEN, MAYNARD, MA (US); Diedrik VERMEULEN, MAYNARD, MA (US)

(21) Appl. No.: 14/486,388

(22) Filed: Sep. 15, 2014

Related U.S. Application Data
(60) Provisional application No. 61/877,677, filed on Sep. 13, 2013.

(51) Int. Cl. G02F 1/225

(52) U.S. Cl. CPC G02F 1/2255; G02F 1/2257; G02F 2203/50

(57) ABSTRACT

Disclosed are structures and methods for optical isolation based on tandem phase modulators in a long interferometer that advantageously provides low-loss, broadband isolation in a photonic integrated circuit without requiring special materials or fabrication steps.

### CROSS REFERENCE TO RELATED APPLICATIONS

This application claims the benefit of U.S. Provisional Patent Application Ser. No. 61/877,677 filed Sep. 13, 2013 which is incorporated by reference in its entirety as if set forth at length herein.

### TECHNICAL FIELD

This disclosure relates generally to photonic structures and systems. More particularly, this disclosure pertains to a tandem-phase-modulator-based optical isolator.

### BACKGROUND

Integrated optical isolators are oftentimes needed and employed to isolate lasers and optical amplifiers from back reflections, prevent multi-path interference and make ring lasers oscillate in a single direction. Given their importance to contemporary optical structures and systems constructed therefrom, improved optical isolator structures and methods would represent a welcome addition to the art.

### SUMMARY

An advance in the art is made according to an aspect of the present disclosure directed to structures and methods for wideband optical isolation employing narrow-band tandem phase modulators.

Accordingly, one aspect of the present disclosure is directed to a method of optically isolating an n-arm interferometer, wherein n>1, by providing each waveguide arm of the n-arm interferometer with a tandem-phase modulator wherein each tandem-phase modular includes a first modulator and a second modulator; wherein one modulator of each of the n tandem-phase modulators is driven by a sine wave at frequency f, and the other modulator of each of the n tandem-phase modulators is driven by a cosine wave at frequency f, wherein the two phase modulators in each pair are separated by a waveguide propagation distance defined by v_{g}/(4f) where v_{g} is the optical group velocity in the waveguides; and wherein each one of n the tandem-phase modulators is driven with a different overall RF phase. Further aspects of such optical isolation according to the present disclosure are wherein the relative RF phase in arm n is is 2π(N-1)/N and the overall optical phase is equal in all arms.

### BRIEF DESCRIPTION OF THE DRAWING

A more complete understanding of the present disclosure may be realized by reference to the accompanying drawing in which:

FIG. 1(a) shows a schematic of an illustrative integrated one-arm optical isolator;

FIG. 1(b) shows a schematic of an illustrative integrated two-arm optical isolator according to an aspect of the present disclosure;

FIG. 1(c) shows a schematic of an illustrative integrated four-arm optical isolator according to an aspect of the present disclosure;

FIG. 2 shows a series of graphs illustrating simulated performance of isolator designs according to the present disclosure using a continuous wave (CW) input wherein the rows in the figure show results for the one-arm, two-arm and four-arm designs respectively wherein f=10 GHz;

FIG. 3 shows a shows a series of graphs illustrating simulated performance of isolator designs according to the present disclosure using a broadband input wherein the rows in the figure show results for the one-arm, two-arm and four-arm designs respectively wherein f=10 GHz;

FIG. 4 shows a schematic and photomicrograph of an optical isolator according to the present disclosure fabricated in silicon photonics wherein a grating coupler is not specifically shown;

FIG. 5 shows a graph depicting measured performance of an isolator according to the present disclosure with CW laser input and a reference taken with modulators turned off; and

FIG. 6 shows a graph depicting measured performance of an isolator according to the present disclosure with amplified spontaneous emission input wherein a reference is taken with the modulators turned off.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope. More particularly, while numerous specific details are set forth, it is understood that embodiments of the disclosure may be practiced without these specific details and in other instances, well-known circuits, structures and techniques have not be shown in order not to obscure the understanding of this disclosure.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof Additionally, it is intended that such equivalents include both currently-known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure.

In addition, it will be appreciated by those skilled in art that any flow charts, flow diagrams, state transition diagrams, pseudocode, and the like represent various processes which may be substantially represented in computer readable medium and so executed by a computer or processor, whether or not such computer or processor is explicitly shown.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Finally, and unless otherwise explicitly specified herein, the drawings are not drawn to scale.

Thus, for example, it will be appreciated by those skilled in the art that the diagrams herein represent conceptual views of illustrative structures embodying the principles of the disclosure.

By way of some additional background, we begin by noting that integrated optical isolators are oftentimes needed to isolate lasers and optical amplifiers from back reflections, prevent multi-path interference, and make ring lasers oscillate in only one direction. Such isolation is especially important when a photonic integrated circuit (PIC) contains lasers or optical amplifiers and is connected to an optical fiber plant. One traditional isolation method involves the use of magnetooptic materials [See, e.g., M. Levy, J. R. M. Osgood, H. Hegde, F. J. Cadieu, R. Wolfe, and V. J. Fratello, IEEE Photon. Tech. Lett. 8, 903(1996); and H. Shimizu and Y. Nakano, IEEE Photon. Tech. Lett. 19, 1973 (2007).]

As may be appreciated however, this isolation method involving magnetooptic materials generally requires either deposition of polycrystalline films [See, e.g., L. Bi, J. Hu, P. Jiang, D. Kim, G. Dionne, L. Kimerling, and C. Ross, Nature Photonics 5, 1 (2011)]—which is challenging due to the large number of elements in garnets—or bonding of crystals [See, e.g., Y. Shoji, T. Mizumoto, H. Yokoi, I.-W. Hseih, and R. Osgood, Applied Physics Letters 92, 071117 (2008); M. Tien, T. Mizumoto, P. Pintus, H. Kroemer, and J. Bowers, Optics Express 19, 11740 (2011)]—which is challenging to do on a wafer scale.

In addition, a number of the demonstrations of integrated isolators employing magneto-optic materials have used ring resonators and consequently are narrow band. Also, integrated magneto-optic solutions usually work only for transverse-magnetic polarized light, whereas most PICs work primarily with transverse-electric polarized light. They also usually require placing a magnet on the PIC.

One very different approach as compared to those noted is to use electro-optic modulation. Advantageously, such electro-optic modulation and components may be integrated into a PIC without any special materials or processing steps. One such electro-optic method employs traveling-wave modulators, which give a different modulation depending on the direction of optical propagation. Such designs generally have either a high intrinsic loss and residual frequency shift [See, e.g., S. Bhandare, S. K. Ibrahim, D. Sandel, H. Zhang, F. Wust, and R. Noe, IEEE J. Sel. Topics Quantum Electron. 11, 417 (2005)] or require long modulated sections [See, e.g., Z. Yu and S. Fan, Nature Photonics pp. 91-94 (2009).].

Yet another electro-optic method—which was reported by at least one inventor of the instant application—uses a tandem arrangement of two phase modulators [See, e.g., C. R. Doerr, N. Dupuis, and L. Zhang, Opt. Lett. 36, 4293 (2011)]. This method advantageously exhibits low insertion loss and requires only two short modulators however, it too is narrow band.

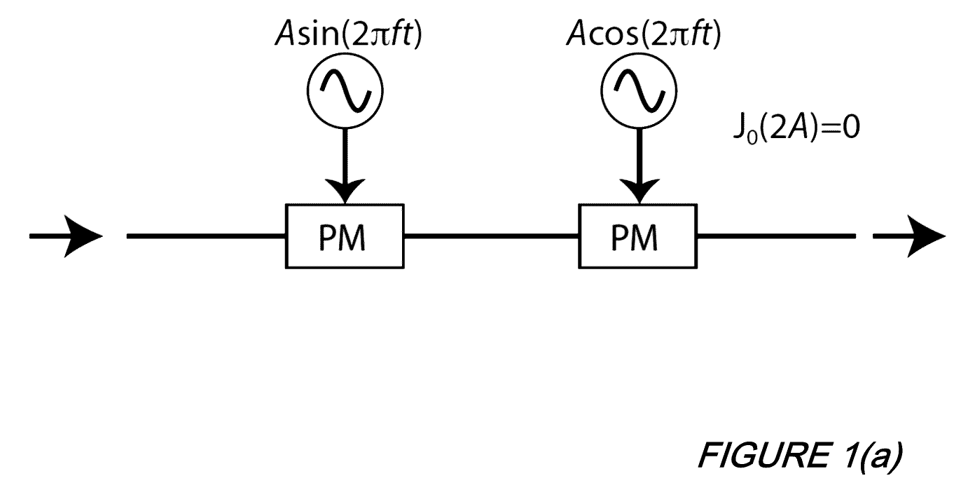

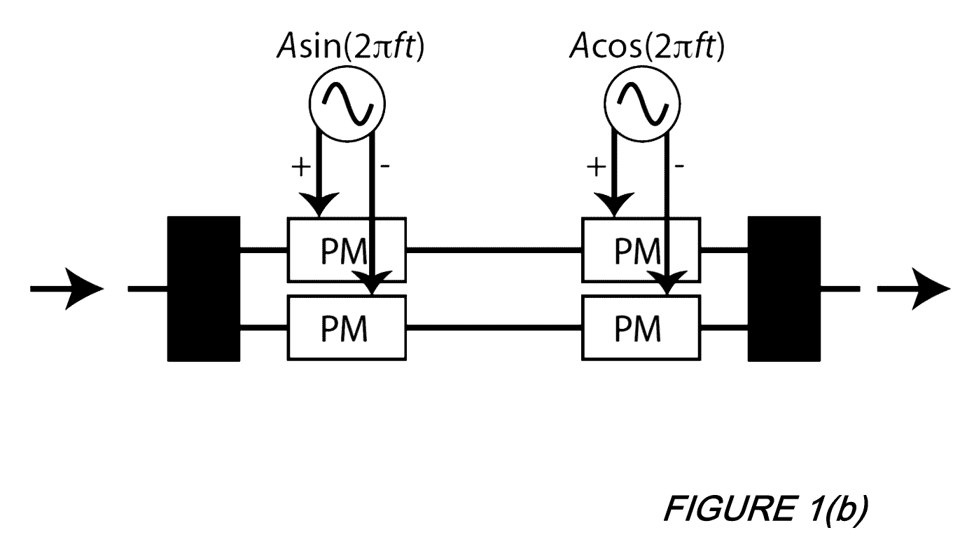

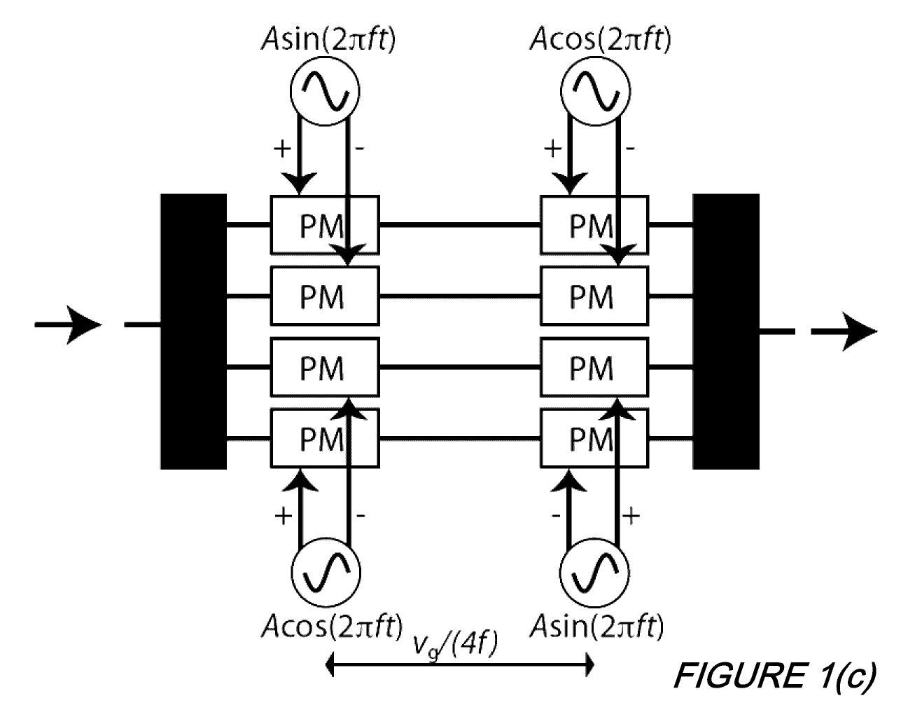

Such a narrow band tandem phase modulator scheme is shown schematically in FIG. 1(a). With reference to that figure, it is noted that with this basic tandem phase modulator scheme, one modulator is driven by a sine wave at frequency f, and the other by a cosine wave also at frequency f The two phase modulators in each pair are separated by a waveguide propagation distance defined by v_{g}/(4f) where v_{g} is the optical group velocity in the waveguides.

With continued reference to FIG. 1(a), when a signal passes from left to right, the transmission is represented by:

e^{jA sin [2πf(t-ΔT)]}e^{jA cos(2πft)} [1]

where ΔT is the time delay between phase modulators and is equal to 1/(4f).

When the signal passes from right to left, the amplitude transmission is represented by:

e^{jA cos [2πf(t-ΔT)]}e^{jA sin(2πft)} [2]

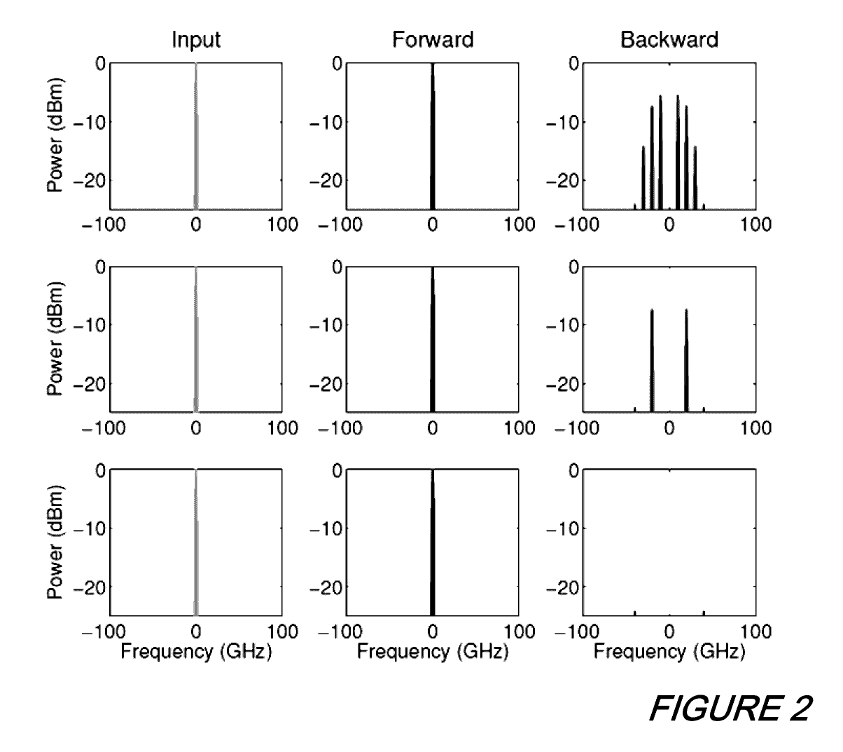

As may be appreciated, there is no effect on the forward signal, and when J₀(2A)=0 (peak-to-peak modulation of 138°) the carrier is fully depleted from the backward signal, and all the backward energy appears at other wavelengths. This can be seen in the simulated performance shown in the top row of FIG. 2.

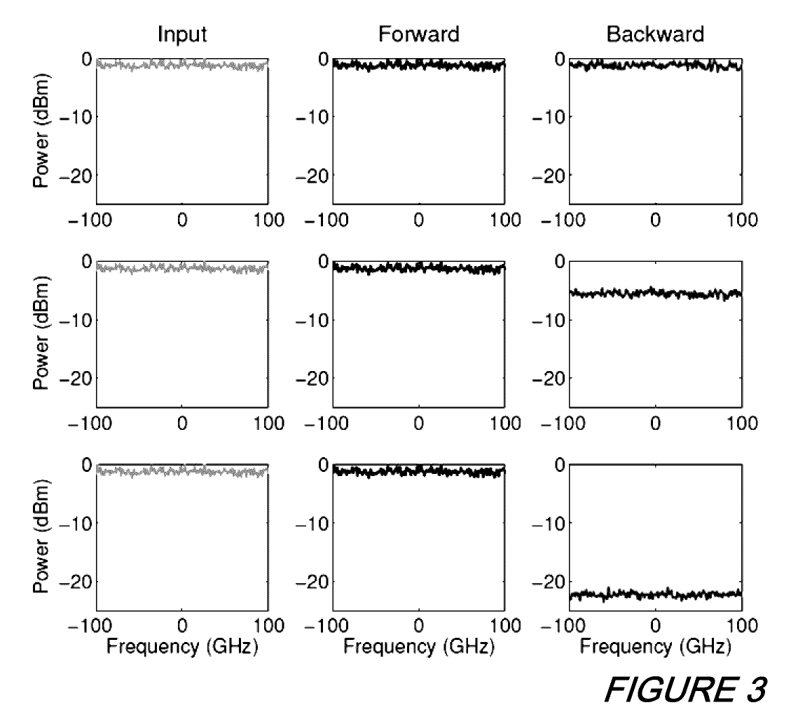

One problem with this design shown in FIG. 1(a) is that the isolation is narrow band. Backwards propagating light is distributed to other frequencies, and thus if a broadband input is applied to the device shown in FIG. 1(b), no isolation is observed—as shown in the top row of FIG. 3.

Turning now to FIG. 1(b) and FIG. 1(c), there is shown a new design for optical isolator structures according to an aspect of the present disclosure. Briefly, the structures include one or more of the above described narrow-band isolator in each arm of an N-arm interferometer.

Notably, and according to an aspect of the present disclosure, the N narrow-band isolators positioned in each arm of the N-arm interferometer are substantially identical except that each is driven with a different overall RF phase. More specifically, the relative RF phase in arm n is 2π(N-1)/N and the optical phase is equal in all arms.

In the forward direction, there is no effect on a signal from each narrow-band isolator, and thus the final combined signal also experiences no effect and 100% transmission. In the backward direction however, because each narrow-band isolator is driven with a different overall RF phase, the generated sidebands interfere destructively, and thus there is broadband isolation. The broadband isolation can be seen in the simulations in the 2nd and 3rd rows of FIG. 3. The larger N is, the higher the isolation.

To facilitate implementation, one would like f to be as low as possible. This can be achieved by lengthening waveguide propagation distance between the two modulators, v_{g}/(4f). Advantageously—and regardless of how low f is—the isolation will remain broadband.

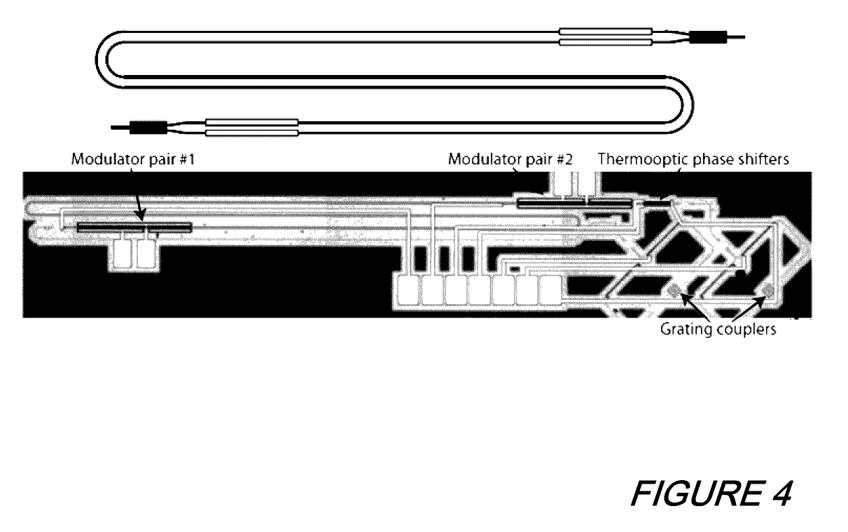

To test the basic principle, we constructed a two-arm optical isolator in silicon photonics. A schematic and photograph of the device are shown in FIG. 4. As may be observed from that figure, there are two pairs of push-pull current-injection plasma-effect modulators in a two-arm interferometer. The modulators are ˜600 mm long. The width of the intrinsic layer is ˜1.75 mm. Each push-pull pair is connected n to n in series with a bias control connected to the n terminals. The waveguide length between the modulator pairs is ˜7.8 mm, and thus the ideal modulation frequency is ˜2.4 GHz

Furthermore, the structure includes a thermooptic phase shifter to control the relative phase in the long interferometer. The input/output coupling to the PIC is via two 1-D grating couplers (not specifically shown). We aligned a fiber assembly to the PIC to couple light in and out of the isolator. Each modulator pair is driven with a 50-W ground-signal probe. The bias voltage was −0.5V. The modulator bandwidth was 300 MHz. Because of the low bandwidth, the modulator response at 2.4 GHz was weak. To compensate, we drove the modulators at 2.0 GHz at 10V peak-to-peak. Despite this, the peak-to-peak modulation was significantly less than the desired 138°, limiting the achievable isolation.

We first launched a cw laser through the device. The fiber-to-fiber insertion loss at 1550 nm was 11.1 dB. The estimated loss breakdown is the following: 7 dB from fiber coupling in and out, 2 dB waveguide propagation loss, 1 dB from the 1×2 multimode interference couplers, and 1 dB from the two modulators.

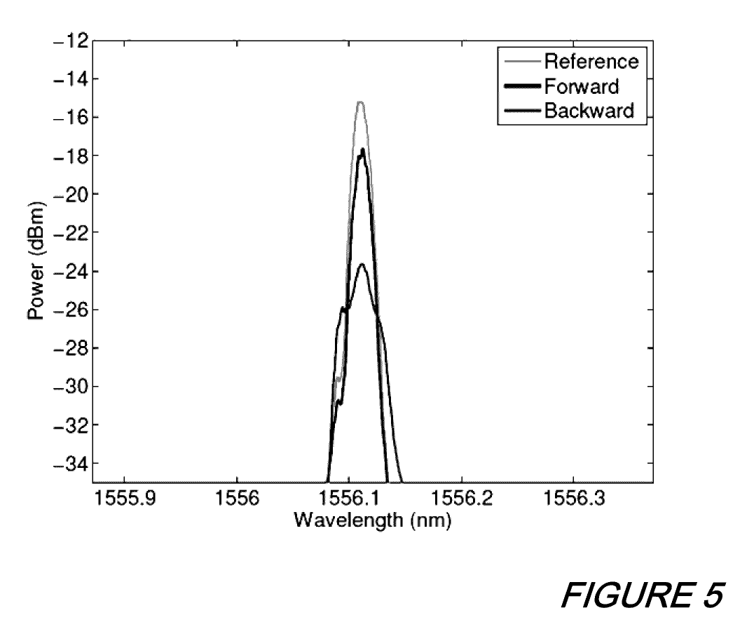

We drove both modulator pairs with 2.0-GHz sine waves. We adjusted the RF phase between the drives such that in the forward direction there was no effect on the laser signal, and we adjusted the optical phase between the interferometer arms for maximum forward transmission. We swapped the input and output connections (without readjustment of the RF and optical phases) to measure the backward signal. The measured performance for the CW laser input is shown in FIG. 5 as measured using an optical spectrum analyzer. Notably, the spectrum analyzer cannot fully resolve the 2-GHz features, but one can see that the narrow-band isolation is ˜5 dB, limited by insufficient modulation amplitude. The signal when the modulation is turned off is ˜3 dB higher than the forward direction. This loss is due to residual amplitude modulation due to free-carrier absorption that accompanies the phase modulation, which also limits the achievable isolation.

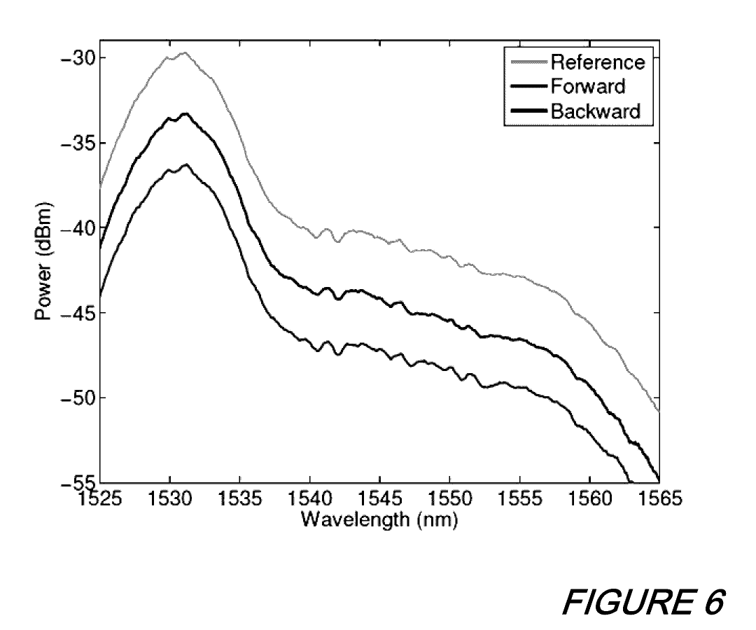

We then launched amplified spontaneous emission from an Er-doped fiber amplifier into the device. The measured spectra are shown in FIG. 6. As may be observed, 3.0 dB of isolation over the C-band was achieved. While this isolation is less than the theoretical value of 6 dB for a two-arm design, it nevertheless does confirm our surprising results and is further improved significantly by using a four-arm design such as that shown in FIG. 1(c).

Accordingly, the present disclosure exhibits a novel broadband integrated optical isolator that advantageously uses low modulation speeds, does not require any special materials or fabrication, and has low intrinsic insertion loss. Our exemplary sample structures achieved at least 3 dB of broadband isolation.

At this point, those skilled in the art will readily appreciate that while the methods, techniques and structures according to the present disclosure have been described with respect to particular implementations and/or embodiments, those skilled in the art will recognize that the disclosure is not so limited. More specifically and as generally described, isolators according to the present disclosure may be applied to modulators exhibiting any number of arms. Accordingly, the scope of the disclosure should only be limited by the claims appended hereto.

1. A method of optically isolating an n-arm interferometer wherein n>1, said method comprising the steps of:
providing each waveguide arm of the n-arm interferometer with a tandem-phase modulator wherein each tandem-phase modular includes a first modulator and a second modulator;
wherein one modulator of each of the n tandem-phase modulators is driven by a sine wave at frequency f and the other modulator of each of the n tandem-phase modulators is driven by a cosine wave at frequency f,
wherein the two phase modulators in each pair are separated by a waveguide propagation distance defined by v_{g}/(4f) where v_{g} is the optical group velocity in the waveguides; and
wherein each one of n the tandem-phase modulators is driven with a different overall RF phase.

2. The method according to claim 1 wherein the relative RF phase in arm n is is 2π(N-1)/N and the overall optical phase is equal in all arms.

3. The method according to claim 1 wherein n=2.

4. The method according to claim 1 wherein n=4.

5. The method according to claim 1 further comprising lengthening the waveguide propagation distance between the two modulators.
